(19) United States
(12) Patent Application Publication
(10) Pub. No.: US 2004/0202927 A1
(43) Pub. Date: Oct. 14, 2004

(54) Cell spacer for a battery pack

(76) Inventors: Sandra L. Drea, Roswell, GA (US); Warren B. Albert, Watkinsville, GA (US)

Correspondence Address: Philip H. Burrus, IV, Motorola, Inc., Law Department, 1700 Belle Meade Court, Lawrenceville, GA, 30043, US

(21) Appl. No.: 10/411,679

(22) Filed: Apr. 12, 2003

(51) Int. Cl. H01M 2/14; H01M 2/10; H01M 2/16

(52) U.S. Cl. 429/129; 429/247; 429/100

(57) ABSTRACT

A battery pack having a spacer is provided. The spacer has several features including adding height to the overall internal structure of the pack so that the circuitry aligns with the top of the battery pack. The spacer provides flat surface to accommodate spot welding of electrical contacts to the circuitry substrate within the pack. The spacer facilitates alignment of the substrate by matching alignment posts with a copper supported hole in the substrate. The alignment posts are slightly larger than the substrate holes and thus, allow press-fitting to securely hold the substrate in place. The spacer includes at least one aperture for protecting oversized components. The spacer includes guide rails for wires or metal tabs to rest against. The rails prevent the tab from making contact with the cells below and potentially shorting out the battery pack.

### BACKGROUND

1. Technical Field

This invention relates generally to rechargeable battery packs, and more specifically to mechanical spacers for rechargeable battery packs that stabilize cells and interior components.

2. Background Art

Modern portable electronic devices, like cellular telephones, radios and pagers, owe their portability to rechargeable batteries. Such batteries allow these devices to slip the surly bonds of wall mounted power supplies and touch the face of the user wherever he may be. They also save consumers money in comparison to single use, replaceable batteries.

Rechargeable battery packs are generally manufactured in rigid, plastic outer housings. The outer housing of the battery pack is designed such that it will easily attach to a portable electronic device. While some may think that rechargeable battery packs are nothing more than “cells in a box”, nothing could be farther from the truth. In addition to the rechargeable cells themselves, battery packs often include sophisticated components including: temperature sensors, protection circuits, fuel gauging circuits, and substrates upon which the internal components reside. Additionally, electrical contacts on the outside of the battery pack must be electrically coupled to the circuitry inside. This coupling is typically accomplished by welding.

The welding process requires that the battery pack substrate and exterior electrical contact be pinched between a rigid surface and a welding electrode. Prior art batteries accomplish the welding process by leaving a floppy piece of substrate sticking out of the battery pack to which a metal electrical contact is welded. The resulting substrate/contact combination is then inserted into a slot in the outer battery pack housing.

The problem with this prior art solution is that the substrate/contact combination may “uninsert” from the slot during use. When this occurs, not only does the battery pack become inoperable, but unsightly, floppy contacts are left dangling about in the breeze. Such dangling contacts may come into contact with other contacts, potentially creating short circuit conditions.

To further complicate matters, nickel based batteries often include a positive temperature coefficient (PTC) device that prevents high currents during short circuit conditions. A polymeric PTC is a device that protects circuits by going from a short (low impedance) to an open circuit (high impedance) when large currents flow through the PTC. A PTC is essentially two pieces of metal with a matrix of crystalline organic polymer sandwiched in between. A PTC resembles a square Oreo® cookie, with metal plates as the cookie halves and crystalline polymer as the ever so tasty cream filling. The active element in a PTC is the polymer, and it takes the form of a malleable “goo” much like the filling in an Oreo®. Under normal conditions, current flows from one cookie through the filling to the other cookie. Under short circuit conditions however, the high current flowing through the PTC causes the device to heat, which in turn causes the filling of the cookie to go into a high impedance state, thereby blocking current and effectively disconnecting the battery cell from the external terminals.

There are several problems associated with PTC devices. The foremost problem can occur during manufacturing. As stated above, a PTC is like an Oreo®, with metal plates as cookies and the polymer as the filling. In order for the PTC to work properly, the two metal plate cookies must remain separated by the polymer filling. If a person or machine pinches the two plates together, the PTC becomes a short and no longer functions as a protection device. Thus, when an assembler assembles a prior art battery pack by inserting contacts into slots in the housing, he must be certain not to either pull the substrate or insert to contact too far as to squish the Oreo® inside.

There is thus a need for an improved battery pack that both allows welding of electrical contacts and prevents the Oreo® from being squished.

### BRIEF DESCRIPTION OF THE DRAWINGS

FIG. 1 is a perspective view of a spacer in accordance with the invention.

FIG. 2 is a perspective view of a spacer in accordance with the invention.

FIG. 3 is an exploded view of a battery pack in accordance with the invention.

FIG. 4 is a sectional view of a battery pack having a spacer in accordance with the invention.

FIG. 4 is a sectional view of a spacer in accordance with the invention, where the sectional view is cut through an aperture in the spacer.

FIG. 6 is a plan view of a spacer having a substrate disposed thereon in accordance with the invention.

FIG. 7 is a sectional view of a battery pack having a spacer in accordance with the invention.

FIG. 8 is a sectional view of a battery pack having a spacer in accordance with the invention, where the section is taken a component protection posts.

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

A battery pack having a spacer is described herein. The spacer facilitates the following: it allows electrical components to be easily welded to the substrate of the battery pack with no floppy pieces and no contact insertion; it supports the substrate during the welding process; it aligns the substrate during assembly; it protects large circuit components within the battery pack; it spaces cells to keep them stable in the field; and it prevents shorting of the metal plates of the PTC (i.e. squishing the Oreo®).

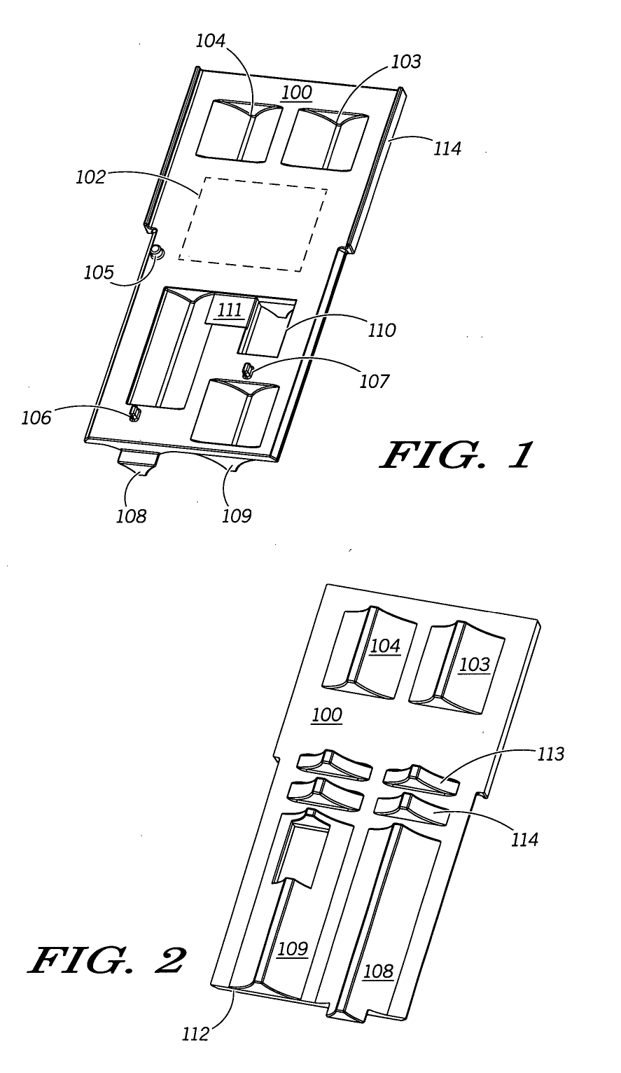

Referring now to FIG. 1, illustrated therein is a perspective view of a spacer 100 in accordance with the invention. The view of FIG. 1 is a top, front, right view of the spacer 100. The spacer 100 is preferably constructed from a rigid plastic material formed by way of an injection molding process. Preferred types of plastic include acrylonitrile butadiene styrene (ABS), polycarbonate (PC) and polycarbonate-ABS due to their durability. Other equivalents known in the art, like styrene for example, may be substituted.

One object of the spacer 100 is to support a substrate within a battery pack. The substrate may be rigid, like a printed circuit board, or may be flexible, like Kapton® encapsulated copper. The spacer 100 includes a flat portion 102 that is capable of supporting a substrate having electrical contacts disposed thereon during a welding process. The flat portion 102 is at least 1 cm², and preferably between 1 and 4 cm². The spacer 100 optionally includes one or more alignment pins 105 for aligning a substrate relative to the spacer 100.

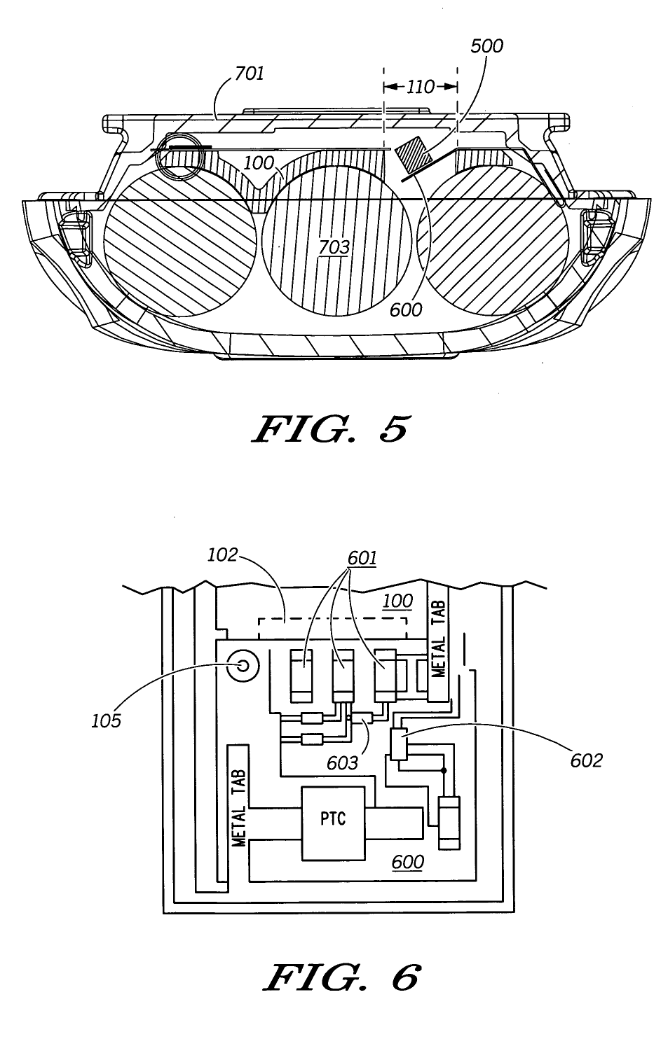

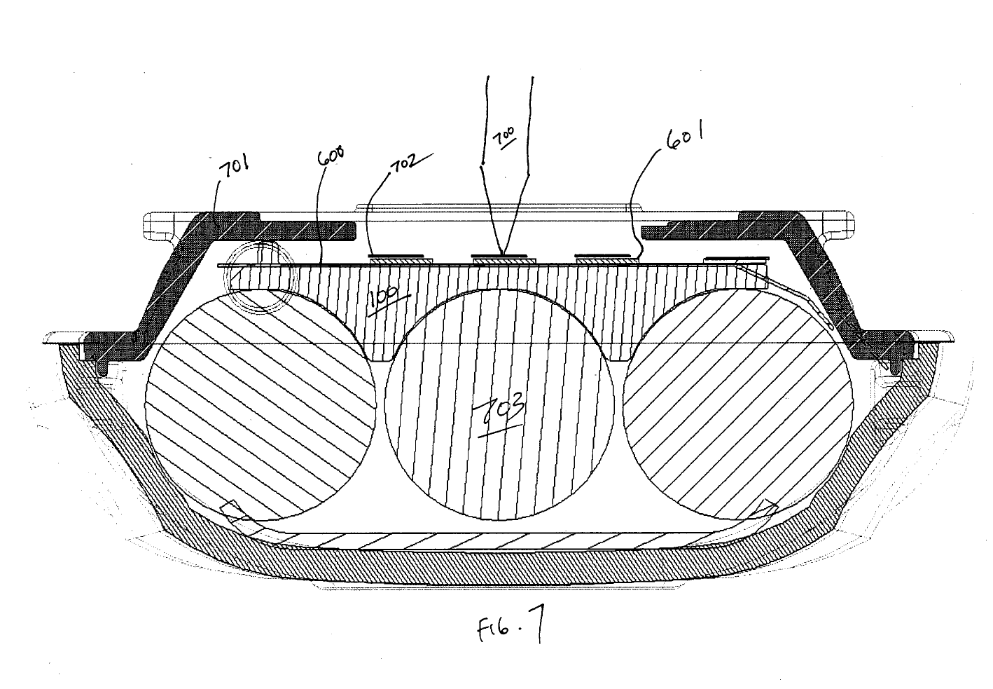

Referring now to FIG. 6, during manufacture, a substrate 600 is placed across the flat portion 102 of the spacer 100. The substrate includes electrical components, e.g. 602, 603, and at least one electrical contact 601. If an alignment pin 105 is employed, the alignment pin 105 passes through a copper supported hole within the substrate to ensure that the substrate is properly aligned relative to the spacer 100. If the alignment pin 105 is slightly larger than the hold in the substrate 600, friction will allow the substrate 600 press-fit onto the alignment pin 105. For example, if the alignment pin 105 were 1 mm in diameter, the hole in the substrate 600 might be 0.9 mm in diameter.

Referring now to FIG. 7, when a cover 701 having a second set of electrical contacts 702 coupled thereto (perhaps by way of insert molding the second set of electrical contacts 702 into the cover 701), the spacer 100 supports the substrate and electrical contacts 601,702 during welding. For example, when a pinch welding fixture 700 presses against the first set 601 and second set 702 of electrical contacts, the spacer 100, by way of the flat portion, provides support against the force of the pinch welding fixture 700. Thus, the first set 601 and second set 702 of electrical contacts may be welded together without damaging the rechargeable cells 703 that lie beneath the spacer 100.

Referring again to FIG. 1, the spacer 100 optionally includes at least one aperture 110. The aperture 110 allows large components, like high current diodes, transistors and the like, which are disposed upon the substrate, to pass through the aperture 110. This “passing through” by large components facilitates a thinner overall battery pack in that it prevents interference between large components and the outer housing. This is best illustrated with the following example:

Referring now to FIG. 5, illustrated therein is a diode 500 coupled to a flexible substrate 600. A “U”-shaped cut is placed in the substrate 600 and the aperture 110, aligning to the top of the U, is placed in the spacer 100. The aperture 110 in the spacer 100 allows the substrate 600 to bend, thereby allowing the diode 500 to pass through the aperture 110. When the diode 500 passes through the aperture 110, the overall thickness of the battery pack is reduced in that the cover 701 does not interfere with the diode 500. Note that the spacer 100 is shown in a cross sectional view in FIG. 5.

Referring again to FIG. 1, the spacer 100 optionally includes at least two component protection posts 106,107. If the outer battery housing is manufactured from plastic, it will have some flexibility. Thus, a large force load may deform the outer housing. If this is in the vicinity of a pressure sensitive component like the PTC, battery reliability may be compromised. To prevent this, component protection posts 106,107 are added. The height of the component protection posts 106,107 is at least as high as the component they are intended to protect. They are well suited for PTC devices, although they may be used about other devices as well.

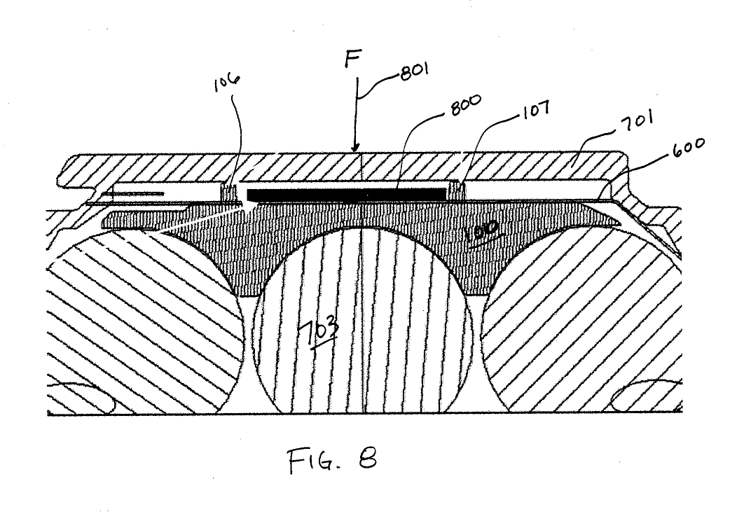

Referring now to FIG. 8, illustrated therein is the protection of a component by way of the component protection posts 106,107 in accordance with the invention. When the cover 701 is coupled to the battery pack, forces acting along the vector 800 attempt to deflect the cover 701. The component protection posts 106,107 prevent a deflecting cover 701 from coming in contact with the component 800.

Referring again to FIG. 1, the spacer optionally includes at least one recess 111 for strain relief of the substrate. The recess 111 is created by reducing the overall thickness of the spacer 100 by not more than 1 mm. A recess 111 may needed when a large component is soldered to a flexible substrate. The heat involved in the soldering process may slightly deform the substrate. Recesses 111 in the spacer, located below component soldering pads, reduce chances of the component accidentally breaking free of the substrate.

Referring now to FIGS. 1 and 2, the spacer includes battery support features 103,104,108,109 for coupling to at least one battery. In the exemplary embodiment of FIGS. 1 and 2, the battery support features have been designed to accommodate rows of AA sized nickel metal hydride cells by making the radii of the battery support features equivalent (within commonly accepted tolerances) of the radii of the cells, although the invention is not so limited. It will obvious to those of ordinary skill in the art that the spacer could easily be tailored to accommodate other sizes, including 18-650 cylindrical cells, rectangular cells, prismatic cells of various shapes and the like.

Battery support feature 108 is extended beyond the end 112 of the spacer 100. While this extension is optional, it allows the spacer to sit within the battery pack at a place of the designer's choosing. For example, if the spacer is half the length of the battery pack, by extending battery support feature 108 a distance equal to one quarter of the length of the battery pack, the spacer 100 will be located at the center of the battery pack. Note that battery support features 112 and 114 have been spaced apart from support feature 108. Spacing apart smaller battery support features (e.g. 113,114) allows the spacer 100 to be longer without fear of plastic deformation caused by large amounts of plastic cooling at different rates in the mold.

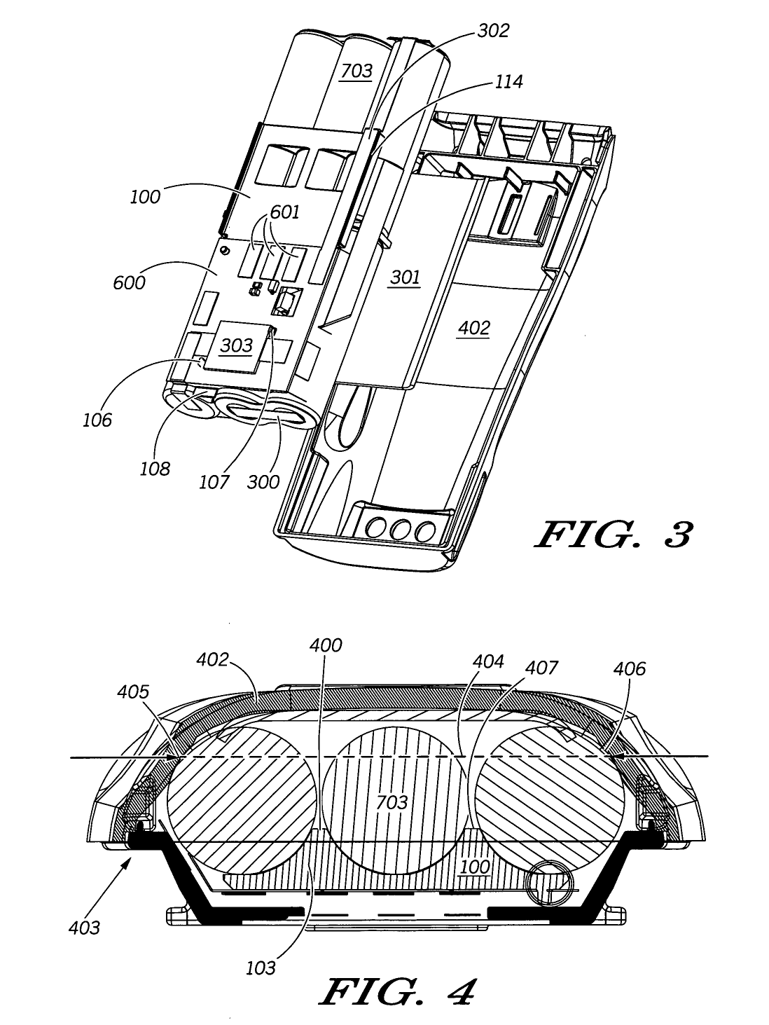

Referring now to FIG. 4, illustrated therein is a cell distribution feature of the invention. Prior to discussing FIG. 4, a bit of background is in order: Many portable electronic device manufacturers like to offer different types of battery packs for their products. For example, a radio manufacturer may offer a nickel battery at one price and a lithium battery at another price. The outer form factor of both batteries must be the same to maintain a constant overall product appearance. Prior art batteries had to manufacture different battery housings (with different interior cavity dimensions) to accommodate different battery sizes and shapes. The spacer of the present invention reduces the cost of manufacturing batteries by allowing a single battery housing to accommodate various battery types.

As shown in FIG. 4, the spacer 100 mechanically aligns the rechargeable cells 703 within the battery pack 403. The battery support features 103 are capped with a flat surface 400. By varying the width of the flat surface 400, the cells 703 may be spaced so as to fill the housing 402 by just touching the housing 402 at the tangent points 405,406. The preferred width of the flat surfaces is within five percent of the length of the tangent line 404, less the widths of the cells 703, divided by the number of flat surfaces 400,407. In the exemplary embodiment of FIG. 4, the width of the peak would be within five percent of the length of line 404, less three cell 703 widths, divided by two (the number of flat surfaces 400,407).

Referring again to FIG. 1, note that guide rails 114 are disposed upon the spacer. Any number of guide rails may be included to guide metal tabs and wires that may run throughout the battery pack. While in this exemplary embodiment the guide rails 114 are on the edges of the spacer 100, it will be obvious to those of ordinary skill in the art that the guide rails could be at numerous other locations on the spacer. The guide rails 114 prevent any metal tabs from making contact with the cells below and potentially shorting out the battery pack. The guide rails 114 also assist operators on manufacturing lines to align any tabs prior to spot welding or soldering.

Referring now to FIG. 3, illustrated therein is an exemplary application for a spacer in accordance with the invention. The spacer 100 is used in a rechargeable battery pack, as shown in this exploded view. The battery pack housing 402 has one or more cells 703 disposed therein. An optional piece of adhesive 301 may be used to secure the cells 703 into the housing. In this exemplary embodiment, a group of six AA NiMH cells 703 are coupled together by welded tabs 300. The spacer 100 is seated against the cells 703, and supports the substrate 600. Electrical contacts 601 disposed upon the substrate 600 may be welded to electrical contacts insert molded into a cover (not shown) using the spacer 600 as support. A PTC 303 is seated between the component protection posts 106,107, which protect the PTC 303 from external forces placed on the cover. The guide rail 114 supports a metal tab 302, and prevents the tab 302 from contacting the cells 703. The extended cell support feature 108 causes the spacer 100 to be positioned more to the center of the battery pack.

While the preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. For example, while the invention has been shown to support cylindrical cells, it will be clear to those of ordinary skill in the art cells of other geometries could be equally supported simply by changing the shape of the cell support features.

What is claimed is:

1. A spacer for a battery pack, comprising:
a. at least one battery support feature;
b. at least one alignment pin for aligning a substrate relative to the spacer;
c. at least one component protection post;
d. at least one aperture; and
e. at least one guide rail.

2. The spacer of claim 1, wherein the at least one battery support feature is capped with a flat surface.

3. The spacer of claim 2, wherein the width of the flat surface is within five percent of the length of the tangent line of the battery pack, less the widths of battery cells disposed within the battery pack, divided by the number of flat surfaces.

4. The spacer of claim 1, wherein the at least one battery support feature is segmented into small sections to prevent deformation of the spacer during injection molding.

5. The spacer of claim 1, wherein the at least one battery support feature extends beyond an end of the spacer.

6. The spacer of claim 1, 4 or 5, wherein a radii of the at least one battery support feature is equal with the radii of a battery cell disposed within the battery pack.

7. The spacer of claim 1, 4 or 5, wherein the spacer further comprises at least one recess for strain relief.

8. The spacer of claim 1, wherein the spacer comprises at least two component protection posts, further wherein the at least two component protection posts are at least as tall as an electrical component disposed between the at least two component protection posts.

9. The spacer of claim 1, wherein the at least one component protection post is larger than a mating hole in the substrate.

10. The spacer of claim 1, further comprising a flat portion capable of supporting the substrate during a welding process.

11. The spacer of claim 10, wherein the flat portion is between 1 mm² and 4 mm².

12. The spacer of claim 1, wherein the spacer is manufactured from a material selected from the group consisting of ABS, PC, PC-ABS and styrene.
